(19) United States
(12) Patent Application Publication
(10) Pub. No.: US 2002/0188462 A1
(43) Pub. Date: Dec. 12, 2002

(54) Business method for insurance or service contract coverage on concrete

(76) Inventor: Steven M. Zimmerman, Overland Park, KS (US)

Correspondence Address: Steven M. Zimmerman, 5833 Newton St., Overland Park, KS, 66202, US

(21) Appl. No.: 10/124,831

(22) Filed: Apr. 18, 2002

Related U.S. Application Data
(60) Provisional application No. 60/284,647, filed on Apr. 18, 2001.

(51) Int. Cl. G06F 17/60

(52) U.S. Cl. 705/1

(57) ABSTRACT

My business method for concrete coverage insurance or service contracts for home or business owners is calculated by figuring the square footage of an area and linear footage for foundations. The premium is figured by demographics with deductibles in place for high or low loss, which sets the premium. Policy duration will be determined by experience of loss, but for the time being, will last between 1 and 5 years, and will be transferable. This is possible using all the technology an insurance company has to offer in the industry today with inspections on a property depending on demographics. This will be coverage that is not now written by any company. This will be a valuable business to most concrete companies in repair, both new and replacement. The trained inspector will catch problems before they become major structural problems. At the same time, the company will be training property owners on loss prevention and maintaining their concrete. My business method of calculating a premium with fixed deductibles will leave a home or business owner knowing his costs and will show how an insurance or service contract company will profit.

### FEDERALLY SPONSORED RESEARCH

Not Applicable

### SEQUENCE LISTING OR PROGRAM

Not Applicable

### BACKGROUND

1. Field of Invention

This business method relates to providing insurance or a service contract to the homeowner to protect their concrete.

2. Description of Prior Art

Currently, concrete is not covered by insurance under a homeowner's insurance policy when there is a problem caused by earth movement. My method will provide a homeowner or business with complete insurance on their concrete.

There are service contracts for vehicles, such as, U.S. Pat. No. 6,182,048 to Osborn (2001), and U.S. Pat. No. 5,855,005 to Schuler (1998), for casualty premiums, but these offer nothing in respect to coverage on concrete either by service contract or insurance.

This business method and software computation will benefit all homeowners and businesses with maintenance, training, and education in the field of concrete and structural integrity relating to their property.

Steel piering of structures, underpinning, and void filling of concrete has made insurance possible and profitable in the field of concrete, masonry, and stone construction. In the “Insurance Professional's Policy Kit,” which major insurance companies use, such as, Allstate, State Farm, and Farmer's, earth movement and concrete are excluded on their policies

### OBJECTS AND ADVANTAGES

The coverage of concrete, masonry, and stone construction, in my above patent, has several objects and advantages, which are:

(a) to provide coverage by insurance or service contract on the home or business owners concrete, masonry or stone structure;

(b) to provide a set charge to the home or business owner on repairs of concrete, settlement of structure or replacement of concrete, masonry, or stone;

(c) to provide an annual inspection of property to check for drainage problems, settlement, voids in concrete or other concerns a property owner may have; and

(d) to provide a risk-sharing coverage among insurance policy customers and service contract customers.

Further objects and advantages are that property owners will be aware of structural problems before they become major problems which mean less damage to home or business property resulting in less replacement of concrete and masonry, making this cost effective and environmentally friendly. This method of insurance or service contract will set a pricing standard in the field of concrete repair, replacement and, also, in masonry and stone structures.

### SUMMARY

My business method will cover concrete by insurance or service contract.

### DRAWINGS

Drawing Figures

FIG. 1 is an area that shows total concrete per square foot, foundation measured by linear foot and steps at one square foot.

FIG. 2 is demographics plus or minus per square foot according to loss ratio.

FIG. 3 is maintained concrete plus or minus per square foot.

FIG. 4 is depreciation on flatwork to be used as a deductible.

FIG. 5 is the premium.

FIG. 6 shows a list of customer's cost or deductibles:

| | | |
|---|---|---|
| (a) | Piering | $400.00 each pier |
| (b) | Underpin | $300.00 each pin |
| (c) | Wall Bracing | $120.00 each brace |
| (d) | Void Filling | $50.00 per square yard |
| (e) | Soil for Drainage | $15.00 per linear foot |
| (f) | Steps | $50.00 each step replacement |
| (g) | Window Wells | $50.00 each new well |
| (h) | Epoxy | $20.00 per linear foot |
| (i) | Waterproofing | On Individual Basis |

### DETAILED DESCRIPTION

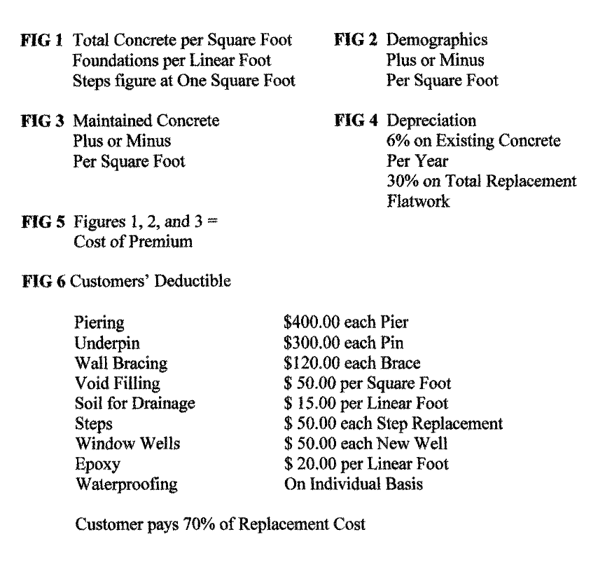

FIG. 1 is a method for calculating the start of the premium for concrete insurance and service contracts.

FIG. 2 is the demographics according to the loss ratio plus or minus per square foot.

FIG. 3 is determined plus or minus if their concrete has been maintained or not, with good drainage, void filling, and underpinning footings.

FIG. 4 is depreciation determined by approximately 6% per year on existing concrete with customer to save 30% on total replacement of flatwork according to current market rate.

FIG. 5 is FIGS. 1, 2, and 3 computed together to arrive at cost of premium.

FIG. 6 is the cost to the customer for maintenance and damage repair.

Advantages

The way of using this method of insurance for service contracts on concrete, masonry, and stone has many advantages:

(a) This will open up a new field of insurance or service contracts that are currently not offered to home or business owners.

(b) A cost price index will be established so companies can start to compile statistics on concrete.

(c) It will make homeowners aware of problems in structures, such as, drainage or minor settlement, before major damage occurs.

(d) Home or business owners will know their costs in advance, which will eliminate unscrupulous contractors who charge outrageous prices on substandard repair or replacement.

Operation

In operation, a customer or agent would measure his or her concrete.

Example per FIG. 1:

| | | |
|---|---|---|
| Basement | 20 × 40 linear feet* = | 800 linear feet |
| Basement Floor | 20 × 30 square feet = | 600 square feet |
| Garage Floor | 20 × 10 square feet = | 200 square feet |
| Sidewalk | 3 × 10 square feet = | 30 square feet |
| Driveway | 20 × 20 square feet = | 400 square feet |
| Patio | 10 × 10 square feet = | 100 square feet |
| Porch | 5 × 10 square feet = | 50 square feet |
| | TOTAL = | 2,180 SQUARE FEET |

*Linear Feet are counted as square feet in calculations.
*Steps are counted as one (1) square foot.

The first example will show a person who has 2,180 square feet, who is in the LOW demographic area for losses (See FIG. 2), and HAS maintained his concrete (See FIG. 3). So, his premium will be based on seven cents ($0.07) per square foot. When you take 2,180×$0.07, it equals $152.60. This is the amount his premium will be for the first year. Thereafter, each year, everything will be assessed again to arrive at a new premium, if warranted.

The second example will show a person who has 2,180 square feet, who is in the LOW demographic area for losses (See FIG. 2), and HAS NOT maintained his concrete (See FIG. 3). So, his premium will be based on ten cents ($0.10) per square foot. When you take 2,180×$0.10, it equals $218.00. This is the amount his premium will be for the first year. Thereafter, each year, everything will be assessed again to arrive at a new premium, if warranted.

The third example will show a person who also has 2,180 square feet, but is in the HIGH demographic area for losses (See FIG. 2), and HAS NOT maintained his concrete (See FIG. 3). So, his premium will be based on three cents ($0.03) for unmaintained concrete, three cents ($0.03) for demographics high in losses, plus seven cents ($0.07), the standard premium, which added together is thirteen cents ($0.13)×2,180 which equals $283.40. This is the amount his premium will be for the first year. Thereafter, each year, everything will be assessed again to arrive at a new premium, if warranted.

Conclusion, Ramifications, and Scope

The reader can see this method of insurance or service contract on a home or business has many advantages in that

it permits property owners to know costs of repair or replacement;

it gives policyholders a security on their property that they did not have before;

it provides a way of cost pricing in the industry of concrete;

it will help the environment by teaching the property owner about preventive maintenance on their structures.

The description above contains much specificity. These should not be construed as limiting the scope of my business method, but merely provide some preferred ways of handling this method. The cost will vary from demographic area to area, according to labor and experience rating. For example, in Texas, a deductible on premiums could be lower than in New York.

The scope of my method patent should be determined by the appended claims, rather than by the examples given.

1. A business method to provide insurance and service contracts on concrete, masonry, and stone comprising:
(a) demographic areas will be used to establish a premium,
(b) new technology in void filling, steel piering, and small hydraulic equipment will make this coverage possible and profitable,
(c) to establish a universal pricing policy on repair and replacement of concrete.
